(19) United States
(12) Patent Application Publication
(10) Pub. No.: US 2016/0215686 A1
(43) Pub. Date: Jul. 28, 2016

(54) METHOD TO CONTROL WASTEGATE VALVE ACTUATOR OF ENGINE

(71) Applicant: Caterpillar Inc., Peoria, IL (US)

(72) Inventors: Shawn M. Damm, Lafayette, IN (US); Deepti V. Bhosekar, Dunlap, IL (US); Arvind Sivasubramanian, Peoria, IL (US)

(73) Assignee: Caterpillar Inc., Peoria, IL (US)

(21) Appl. No.: 15/091,441

(22) Filed: Apr. 5, 2016

(51) Int. Cl. F02B 37/18; F01N 3/08

(52) U.S. Cl. CPC F02B 37/183; F01N 3/0842; F01N 2570/14

(57) ABSTRACT

A method to control a wastegate valve actuator by determining a NOx deadband with hysteresis for an engine controller is disclosed. This NOx deadband defines an outer band and an inner band. In this method, a NOx sensor keep sensing the NOx level in the exhaust gases and accordingly the engine controller sends commands to the wastegate valve actuator. At the NOx level less than inner band and the outer band, engine controller remains at deactivated state. When the NOx level goes outside the outer band, the engine controller sends dither command to the wastegate valve actuator and continues to send the dither command until the NOx level does not reach inside the NOx inner band. This method improves life of the wastegate valve assembly as separate activating and deactivating bands for the engine controller ensures less command fluctuations for the wastegate valve actuator.

### TECHNICAL FIELD

The present disclosure relates to a wastegate valve of an exhaust system of an engine. More particularly, the present disclosure relates to a method of controlling a wastegate valve actuator of an exhaust system based on NOx emissions in the engine.

### BACKGROUND

Exhaust gases released by the internal combustion engines contains a complex mixture of air pollutants. These air pollutants may include solid unburnt Hydrocarbon particles, carbon mono oxide (CO), oxides of nitrogen (NOx), and the like. NOx emission standards have grown more stringent because NOx is the most harmful among all air pollutants in the exhaust of the internal combustion engine. Different NOx emission control techniques, such as the engine controller and the intake manifold pressure control by operating the wastegate valve are being adapted. These mechanisms result in significant control of the NOx emissions.

Continuous commands, from the engine controller, to operate the wastegate valve thereby to adjust the air-fuel ratio, produce oscillations in the wastegate valve. To control these oscillations, continuous dithering is applied to the wastegate valve. Continuous dithering may damage the waste gate valve actuation assembly and reduces the component's lifespan.

U.S. Pat. No. 7,168,411 discloses an engine controller using an active wastegate valve to adjust the air-fuel ratio to achieve desired NOx set point based on the intake manifold pressure.

Given description covers one or more above-mentioned problems and discloses a method to solve the problem.

### SUMMARY OF THE DISCLOSURE

Various aspects of the present disclosure describe a method to control a wastegate valve actuator. This method incorporates, determining a NOx level deadband with predetermined hysteresis values for the engine controller. Based on the NOx level with respect to the NOx level deadband, the wastegate valve actuator receives commands to control the wastegate valve from the engine controller. The deadband includes two bands i.e. an inner band and an outer band. The NOx level determined by a NOx sensor is compared with the inner band and the outer band by the engine controller. At the NOx level less than the inner hand, the engine controller gets deactivated and sends a constant output to the wastegate valve actuator. In this case, the wastegate valve remains at its previous position with no oscillations and thus no dither command is required. If NOx level goes outside the inner band and remains inside the outer band, the deactivated state of the controller is maintained and no dither command is sent to the wastegate valve actuator. At NOx level outside the outer band, the engine controller gets activated and enables the dither command for the wastegate valve actuator. The wastegate valve actuator, during changing position of the wastegate valve, applies dithering to the wastegate valve and control oscillations, With change in position of the wastegate valve, the turbocharger unit increases or reduces the air quantity in the air inlet manifold, reducing or increasing the NOx level. After the NOx level reduction, at NOx level more than the inner hand and less than the outer band, activated state of the engine controller is maintained and the dither command is continuously sent to the wastegate valve actuator to avoid command fluctuations in case of oscillating NOx levels. The engine controller gets deactivated and does not send the dither command to the wastegate valve actuator as the NOx level reaches in the inner band.

### BRIEF DESCRIPTION OF THE DRAWINGS

FIG. 1 is a schematic view, showing a power generation assembly, in accordance with the concepts of the present disclosure;

FIG. 2 is a schematic showing a turbocharger assembly connected to an engine system of FIG. 1 and a wastegate valve assembly of the power generation system, in accordance with the concepts of the present disclosure;

FIG. 3 is a graphical representation of a NOx deadhand with hysteresis pre-stored in an engine controller, with the corresponding position of a wastegate valve of the wastegate valve assembly, in accordance with the concepts of the present disclosure; and

FIG. 4 is a flow chart for a method to control a wastegate valve actuator of the wastegate valve assembly of FIG. 2, in accordance with the concepts of the present disclosure.

### DETAILED DESCRIPTION

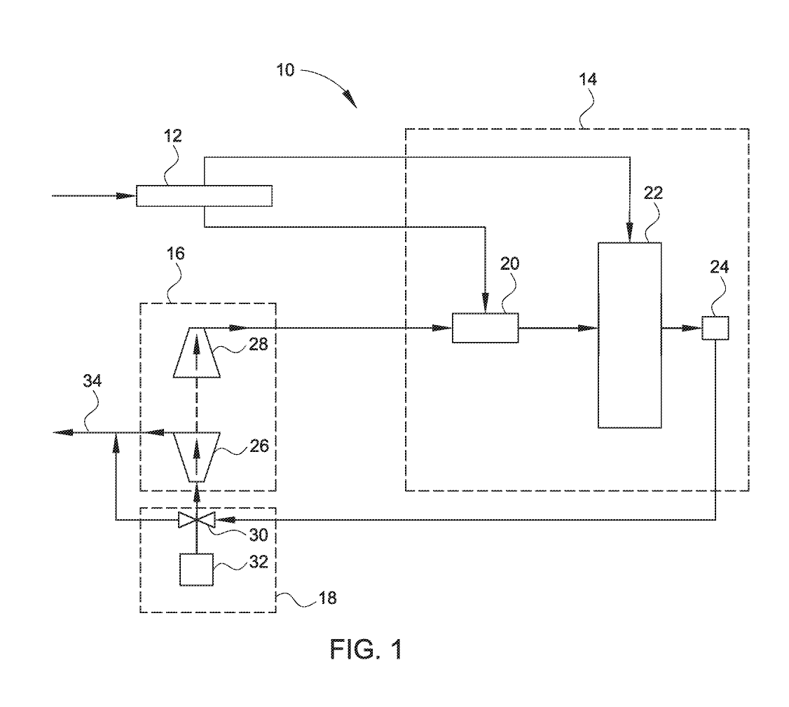

Referring to FIG. 1, a power generation assembly of a vehicle is shown, referred to as a power assembly 10 hereinafter. The power assembly 10 includes a fuel rail 12, an engine system 14, a turbocharger assembly 16, and a wastegate assembly 18. The fuel rail 12 supplies fuel to the engine system 14.

The engine system 14 includes an intake manifold 20, a cylinder 22, and an exhaust manifold 24. The cylinder 22 may include a pre-combustion chamber (not show in figure) and/or a combustion chamber (not shown in figure) facilitating combustion of air-fuel mixture received through the intake manifold 20. The exhaust manifold 24 directs exhaust gases, generated during the combustion in the cylinder 22.

The turbocharger assembly 16 supplies compressed air to the engine system 14 for the air-fuel mixture, via the intake manifold 20. The turbocharger assembly 16 includes a turbocharger turbine 26 coupled with a turbocharger compressor 28. The turbocharger turbine 26 is powered by exhaust gases flowing out of the exhaust manifold 24 of the engine system 14.

The wastegate assembly 18 includes a wastegate valve 30 and a wastegate valve actuator 32. The wastegate valve 30 of the wastegate assembly 18 regulates flow of exhaust gases into the turbocharger turbine 26. In one embodiment, the wastegate valve 30 can be a diverter valve or a spool valve configured to regulate the flow of exhaust gases to the turbocharger assembly 16 by diverting the exhaust gases to the turbocharger turbine 26 or vent the exhaust gases to the atmosphere/an exhaust after treatment system. The flow of exhaust gases is controlled by controlling the position of a gate element (not shown in figures) of the wastegate valve 30. The gate element (not shown in figures) of the wastegate valve 30 is actuated by the wastegate valve actuator 32. The wastegate valve actuator 32 is connected to the gate element and controls its position. In one embodiment, the wastegate valve actuator 32 can be a stepper motor, or a solenoid controlled actuation mechanism configured to selectively adjust the position, and opening/closing of the gate element of the wastegate valve 30. The wastegate valve 30 directs exhaust gases towards the turbocharger turbine 26 as well as vents it to the atmosphere 34 depending on the position of the gate element. The exhaust gases flowing out of the wastegate valve 30 may be recirculated into the intake manifold 20 by an EGR system (not shown in the figure) or may be directed to an after-treatment system (not shown in the figure), before emitting into the atmosphere.

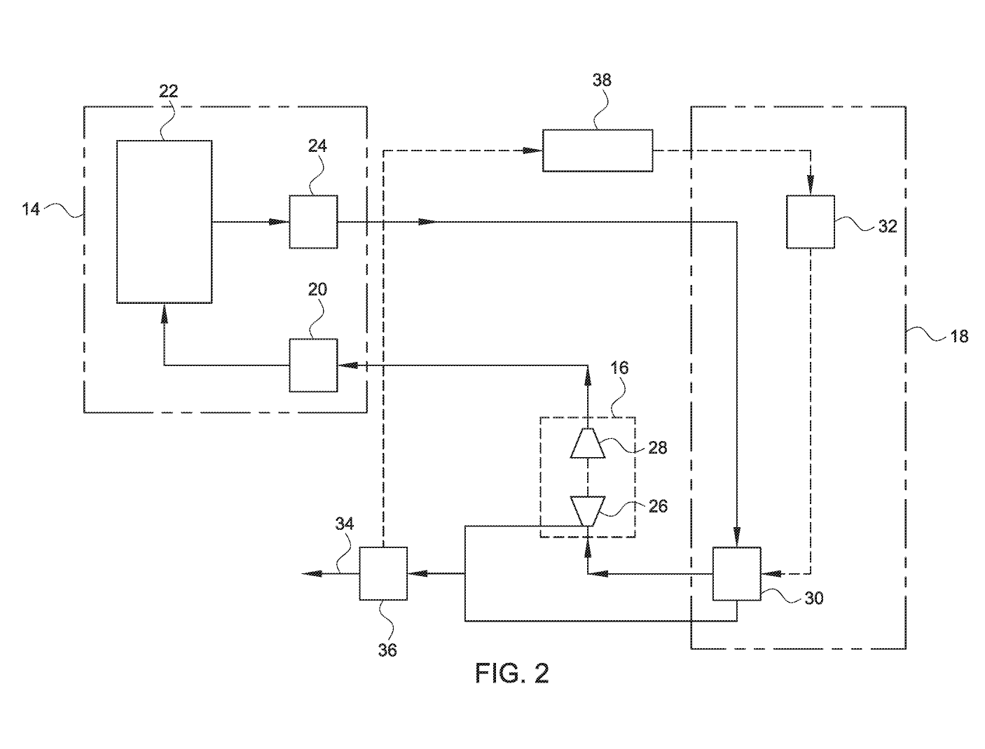

Referring to FIG. 2, the turbocharger assembly 16 is shown connected to the engine system 14 via a NOx sensor 36, an engine controller 38 and the wastegate assembly 18. The NOx sensor 36 is mounted downstream of the exhaust manifold 24. As an exemplary embodiment of the concept, the NOx sensor 36 is mounted downstream of the turbocharger turbine 26 and the wastegate valve 30. The NOx sensor 36 determines the NOx level 42 in the exhaust gases flowing out of the exhaust manifold 24.

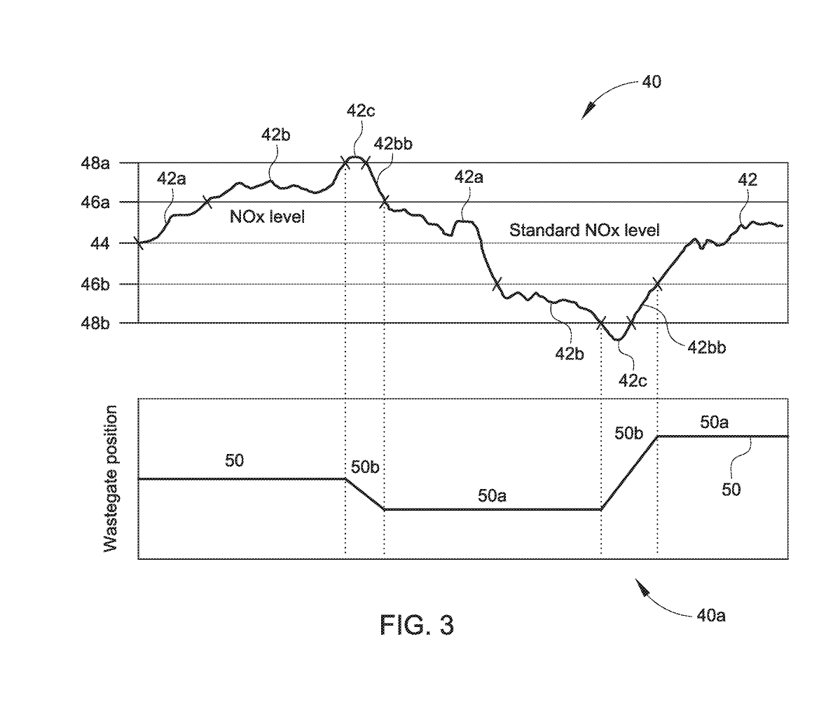

The engine controller 38 receives a determined value of the NOx level 42 (shown in FIG. 3) from the NOx sensor 36 and generates a control command. The control command is communicated to the wastegate valve actuator 32 accordingly. Based on the control command received from the engine controller 38, the wastegate valve actuator 32 adjusts the position of the wastegate valve 30 and controls oscillations by dithering.

It may be noted that the determined value of NOx level 42 in the exhaust gases governs the position of the gate element in the wastegate valve 30. In one embodiment, if a high value of NOx level 42 is determined by the NOx sensor 36, the command signal may cause the gate element of the wastegate valve 30 to close more and divert more exhaust gases towards the turbocharger turbine 26. This may lead to increase in the speed of the turbocharger turbine 26 and hence more air is provided to the cylinder 22 by the turbocharger compressor 28.

It may be noted that in one embodiment, the wastegate assembly 18 can be in-built within the turbocharger assembly 16. In another embodiment, the wastegate assembly 18 can be an external standalone unit functioning in communication with the engine system 14 and the turbocharger assembly 16. In the current disclosure either of the two in-built or standalone wastegate assembly 18 is compatible.

Further FIG. 3 shows a graph 40, describing a NOx deadband with hysteresis. The graph 40 elaborates the corresponding position of the wastegate valve 30 with the changing NOx levels.

The vertical axis (Y-axis) of the graph 40 indicates the NOx level 42 in the exhaust gases as determined by the NOx sensor 36. The horizontal axis (X-axis) indicates the time as the NOx level 42 changes during running of the engine system 14. A solid line 42 indicates the changing value of the NOx level 42 as determined by the NOx sensor 36 over duration of time.

A point on the vertical axis indicates a standard NOx level 44. The standard NOx level 44 is the expected level of NOx as per the type of engine system 14. In other words, during normal operation, the engine system 14 is expecting to produce NOx as per the standard NOx level 44. On either side of the standard NOx level 44, a NOx deadband with hysteresis is provided. The NOx deadband includes a NOx inner band 46 and a NOx outer band 48. The NOx inner band 46 stretches on both sides of the standard NOx level 44. The NOx inner band 46 is further enveloped by the NOx outer band 48. The outer band stretches starting from the outer edge of the NOx inner band 46. As shown in the graph 40, the NOx inner band 46 expanses a range area between 46a and 46b and the NOx outer band 48 expanses a range area between 48a and 48b. The NOx inner band 46a and 46b and the NOx outer band 48a and 48b are determined with respect to a standard NOx level 44 as per NOx regulations.

The total expanse of the NOx inner band 46 and the NOx outer band 48 is defined as the NOx deadband with hysteresis.

Further, a chart 40a indicating the position of the gate element of the wastegate valve 30 is shown below the graph 40. The position of the gate element, corresponding to the NOx level 42 in the graph 40, is indicated by a solid line 50. A section 50a of the solid line 50 indicates no movement of the gate element, whereas the section 50b of the solid line 50 indicates the opening or closing of the gate element.

FIG. 3 in conjunction with FIG. 2, indicate the changing value of the NOx level 42, as determined by the NOx sensor 36. The determined value of the NOx in the exhaust gases is further communicated to the engine controller 38. As shown, the NOx level 42 is indicated on the graph 40 by a section 42a, 42b, 42bb, and 42c of the solid line 42. Further as shown, the section 42a indicates the determined NOx level 42 within the NOx inner band 46, the section 42b and 42bb indicates the determined NOx level 42 within the NOx outer band 48, and the section 42c indicates the determined NOx level 42 beyond the NOx outer band 48. The determined value of the NOx level 42 is compared to the range area of the NOx inner band 46a and 46h and NOx outer band 48a and 48b. The engine controller 38 then generates the command signal for the wastegate valve actuator 32 to accordingly control oscillation of the wastegate valve 30. The control signal may correspond to freezing the engine controller 38 at a deactivated state and disabling a dither command to the wastegate valve actuator 32, when the NOx level 42 is within the NOx inner band 46. This is depicted by the section 42a on graph 40 and section 50a. on the chart 40a. Further, the control signal may correspond to maintaining a preceding state of the engine controller 38 and disabling the dither command to the wastegate valve actuator 32 when the NOx level 42 is more than the NOx inner band 46 and less than the NOx outer band 48. This is depicted by section 42b and 42bb on the graph 40, and section 50a on the chart 40a. Furthermore, the control signal may also correspond to unfreezing the engine controller 38 from the deactivated state to an activated state at the NOx level 42 more than the NOx outer band 48 and enabling the dither command to the wastegate valve actuator 32. This state is depicted by the section 42c and 50b of the graph 40 and the chart 40a, respectively.

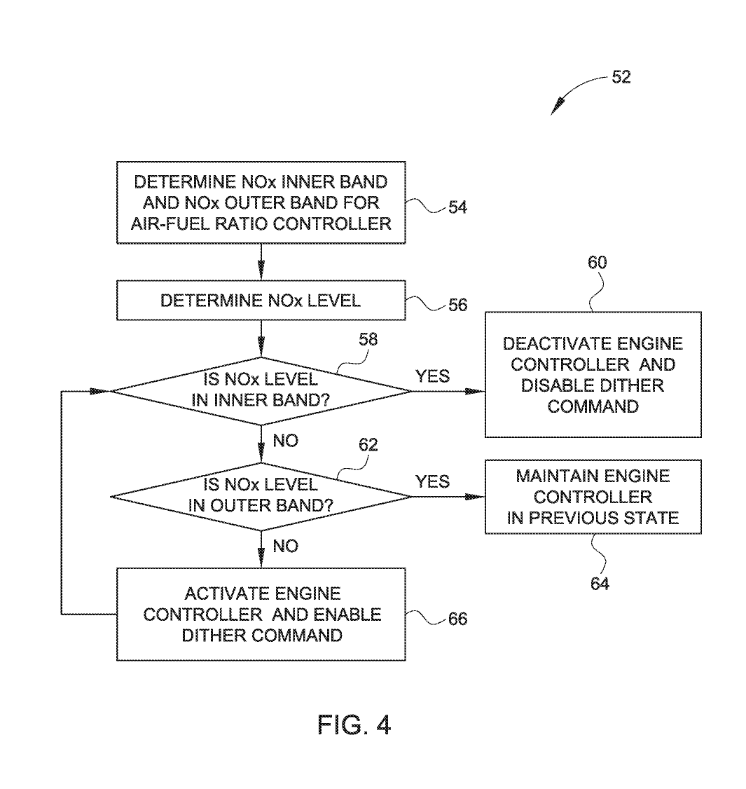

Referring to FIG. 4, a flow chart for a method 52 to control the wastegate valve actuator 32 of the wastegate assembly 18 is described. The method 52 includes a step 54 to determine the NOx inner band 46 with range area between 46a, 46h and the NOx outer band 48 with range area between 48a and 48b with respect to the standard NOx level 44. The determined NOx inner band 46 and the NOx outer band 48 are pre-stored in the engine controller 38. In other words, the engine controller 38 may determine the range area of the NOx inner band 46 and the NOx outer band 48 and store for a later reference. In one embodiment, the engine controller 38 may include a memory unit (not shown in figures) to store the range area of the NOx inner band 46 and the NOx outer band 48. It may be noted that the range area of the NOx inner band 46 and the NOx outer band 48 may be updated and uploaded by an operator of the engine system 14.

At step 56, the NOx sensor 36 determines the NOx level 42 including the NOx level 42a. 42b, 42bb, or 42c in the exhaust gases flowing out of the exhaust manifold 24. The NOx sensor 36 communicates the determined NOx level 42, 42a, 42b, 42bb, or 42c to the engine controller 38 for comparing as per the stored values in the NOx deadband. with hysteresis.

At step 58, the engine controller 38 compares the NOx level 42, 42a, 42b, 42bb, or 42c with the NOx inner band 46. If the NOx level 42a is between the NOx inner band 46a and 46b of the NOx inner band 46, then the method 52 proceeds to step 60. If the NOx level 42b or 42bb is outside the NOx inner band 46a and 46b, then the method 52 proceeds to step 62.

At step 60, the engine controller 38 is deactivated and the dither command for the wastegate valve actuator 32 is disabled.

At step 62, the engine controller 38 compares the NOx value 42b or 42bb with the NOx outer band 48. If the NOx level 42h or 42bb exceeds the NOx inner band 46a and 46b of the NOx inner band 46 and is within the NOx outer band 48a and 48b of the NOx outer band 48 then the method 52 proceeds to step 64, else step 66 is followed.

At step 64, the engine controller 38 remains in a preceding state, that is, remain activated if the engine controller 38 was activated earlier or remain deactivated if the engine controller 38 was deactivated.

In the event of NOx level 42c exceeding the NOx outer band 48a and 48b of the NOx outer band 48, the method 52 follows the step 66 and the engine controller 38 is activated and enables the dither command for the wastegate valve actuator 32. The method 52 to control the wastegate valve actuator 32 based on the determined value of the NOx level 42, 42a, 42b, 42bb, and 42c is further explained in description below.

### Industrial Applicability

As shown in FIG. 1, the fuel rail 12 supplies the fuel to the engine system 14 for ignition of a flame in the cylinder 22. The flame generated in the pre-combustion chamber (not shown in the figures) of the cylinder 22 expands in the combustion chamber (not shown in the figures) and combustion of the air-fuel mixture occurs. The air-fuel mixture flows into the cylinder 22, through the intake manifold 20, The intake manifold 20 receives the fuel from the fuel rail 12 and the intake air from the turbocharger assembly 16. The exhaust gases produced during the combustion exits the cylinder 22 from the exhaust manifold 24. The NOx sensor 36 is mounted downstream of the exhaust manifold 24. As the preferred exemplary embodiment. the NOx sensor 36 is mounted downstream of the turbocharger turbine 26 and the wastegate valve 30. The NOx sensor 36 is configured to determine the value of the NOx level 42 in the exhaust gases exiting the cylinder 22 via the exhaust manifold 24.

The exhaust gases exiting from the exhaust manifold 24 is directed to the wastegate valve 30 of the wastegate assembly 18. The wastegate valve 30 regulates the flow of the exhaust gases towards the atmosphere 34 as well as to the turbocharger assembly 16. The wastegate valve actuator 32 controls the opening and closing i.e. the position of the gate element of the wastegate valve 30. The exhaust gases flowing through the wastegate valve 30 powers the turbocharger turbine 26 that generates compression pressure at the turbocharger compressor 28. With changing compression pressure, the density of the intake air supplied to the cylinder 22 changes and richness of air-fuel mixture varies thereby affecting the NOx level 42 in the exhaust gases.

Referring to FIG. 2 and FIG. 3, the wastegate valve actuator 32 is linked to the engine controller 38. The engine controller 38 is configured to receive determined value of NOx level 42, 42a, 42b, 42bb, and 42c from the NOx sensor 36. Further, the NOx inner band 46a and 46b and the NOx outer band 48a and 48b are pre-stored in the engine controller 38. On receiving the determined value of NOx level 42 from the NOx sensor 36, the engine controller 38 compares the NOx level 42, 42a, 42b, 42bb, and 42c with the NOx inner band 46 and the NOx outer band 48. Thereafter, the engine controller 38 communicates a control signal accordingly to the wastegate valve actuator 32 to control the wastegate valve 30.

Further referring to FIG. 4 in view of FIG. 2 and FIG. 3, the enabling function of the present concept is described by the method 52. The control signal from the engine controller 38 may correspond to freezing the engine controller 38 at a deactivated state and disabling a dither command to the wastegate valve actuator 32. When the NOx level 42 is within the range of the NOx inner band 46. This is depicted by the section 42a of the section 40 and 50a of the chart 40a. Further, the control signal may correspond to maintaining a preceding state of the engine controller 38 and disabling the dither command to the wastegate valve actuator 32 when the NOx level 42 is more than the NOx inner band 46 and within the NOx outer band 48a and 48b of the NOx outer band 48. This is depicted by section 42bb and 50a. In other words, the engine controller 38 continues to remain in the frozen state and disables any dither command, when the determined value of the NOx level 42 exceeds the NOx inner band 46, but is within the NOx outer band 48. Furthermore, the control signal may also correspond to unfreezing the engine controller 38 from the deactivated state to an activated state at the NOx level 42 more than the NOx outer band 48 and enabling the dither command to the wastegate valve actuator 32. This state is depicted by the section 42c and 50b.

At NOx level 42a, the NOx level 42 of the exhaust gases is between the NOx inner band 46a and 46b. Hence, at NOx level 42a, the engine controller 38 is deactivated and does not send any command to the wastegate valve 30. Thereby, the wastegate valve actuator 32 does not change the position of the wastegate valve 30 (that is, the wastegate valve 30 remains in a stable position 48a). With NOx level 42b, outside the NOx inner band 46 and inside the NOx outer band 48a and 48b of the NOx outer band 48, the engine controller 38 remains deactivated and the constant command is sent to the wastegate valve actuator 32.

As the NOx level 42c increases beyond the NOx outer band 48, the engine controller 38 becomes activate, and sends the dither command to the wastegate valve actuator 32. The wastegate valve actuator 32 applies dithering to control the oscillations of the wastegate valve 30 as long as the NOx level 42 remains outside the NOx outer band 48. This is depicted by the changing position section 50b in the chart 40a. With controlled oscillations and changed exhaust gas flow in the turbocharger turbine 26, a lean air-fuel mixture is supplied to the engine that reduces the NOx level 42 in the exhaust gases.

With reducing NOx levels, the NOx sensor 36 again detects the NOx level 42bb and the engine controller 38 compares the NOx level 42bb with the NOx inner band 46 and the NOx outer band 48. As the NOx level 42bb is inside the NOx outer band 48a and 48b, but remains outside the NOx inner band 46a and 46b, the engine controller 38 remains activated and continue to send dither commands to the wastegate valve actuator 32 until the NOx level 42a is achieved.

The many features and advantages of the disclosure are apparent from the detailed specification, and thus, it is intended by the appended claims to cover all such features and advantages of the disclosure that fall within the true spirit and scope thereof. Further, since numerous modifications and variations will readily occur to those skilled in the art. It is not desired to limit the disclosure to the exact construction and operation illustrated and described, and, accordingly, all suitable modifications and equivalents may be resorted to that fall within the scope of the disclosure.

What is claimed is:

1. A method of controlling a wastegate valve actuator regulating a wastegate valve comprising:
determining a NOx inner band and a NOx outer band for an engine controller;
determining a NOx level by a NOx sensor in exhaust gases;
comparing the NOx level with the NOx inner band and the NOx outer band by the engine controller;
freezing the engine controller at a deactivated state and disabling a dither command to the wastegate valve actuator, at the NOx level less than the inner band;
maintaining a preceding state of the engine controller, at the NOx level more than the NOx inner band and less than the NOx outer band; and
unfreezing the engine controller from the deactivated state to an activated state at the NOx level more than the outer band and enabling the dither command to the wastegate valve actuator.
